(19) United States
(12) Patent Application Publication
(10) Pub. No.: US 2010/0228596 A1
(43) Pub. Date: Sep. 9, 2010

(54) COMPUTER ADVERTISING SYSTEM WITH BUILT-IN PER-IMPRESSION CONSUMER FEEDBACK MECHANISM

(76) Inventors: David Simons, Toronto (CA); Girish Limaye, Sunnyvale, CA (US)

Correspondence Address: FOLEY & LARDNER LLP, 150 EAST GILMAN STREET, P.O. BOX 1497, MADISON, WI, 53701-1497, US

(21) Appl. No.: 12/398,734

(22) Filed: Mar. 5, 2009

(51) Int. Cl. G06Q 30/00; G06Q 10/00

(52) U.S. Cl. 705/10; 705/14.69

(57) ABSTRACT

A computer advertising system that has a built-in per-impression consumer feedback mechanism for measuring consumer recognition of an advertising message. A method of advertising based on actual recognition of an advertising message by a consumer can include presenting an advertisement on an interface where the advertisement has at least one advertising message, presenting a consumer feedback mechanism on the interface such that the consumer feedback mechanism is configured to receive an indication of recognition by a consumer of at least one advertising message, receiving the indication of recognition, and optionally determining at a pricing computer an advertising price based at least in part on the received indication of recognition per advertising impression.

### FIELD

The subject of the disclosure relates generally to advertising within a computer software environment. More specifically, the disclosure relates to a computer advertising system that has a built-in consumer feedback mechanism that can be used to measure consumer recognition of an advertising message, and price individual advertisements based on consumers' responses.

### SUMMARY

Advertising models that are currently prevalent online leverage the interactivity of online media for direct sale advertisement (e.g., consumer click-through). However, for brand awareness advertisements where the immediate goal is to deliver or reinforce a message, the current advertising models lack a precise per-impression feedback mechanism for determining whether the consumer understands the message. Current advertisement models often use engagement mechanisms and metrics to infer per-impression recognition, but the inference processes are imprecise. Described herein is a computerized system and method which provide online brand awareness advertisements with advertisement impressions and feedback where a consumer can confirm his or her understanding of the advertising message. The system and method, therefore, includes a form of accounting that is missing in conventional brand awareness advertisements. Since the consumer actively participates in the advertisement and provides a feedback about his or her understanding of the message, there is better advertisement message retention.

Recognition is a process that occurs when some event, process, pattern, or object recurs. Recognition takes place as humans process stimuli with previous memories and experiences and find relationships between the current stimuli and memories. Validation of consumer recognition of a brand awareness advertisement entails the consumer processing an advertisement message and taking action that proves his or her recognition. Standardized methods such as multiple choice tests can be used to measure this recognition. Such a methodology applies, although it is not restricted to linear advertisement formats. When rendering a linear advertisement, the media with which the consumer is interacting is paused, the advertisement is rendered, the media is un-paused and the consumer resumes interaction with the media.

In the case of a linear advertisement format, a system can be set up to reward the consumer for providing feedback in the form of brand awareness recognition. In one embodiment of such a system, traditional advertisement impressions are delivered to a specific consumer “X” number of times, where X is the effective ad frequency for that category of products. The “X+1”^{st} advertising impression consists of an advertisement together with a companion feedback mechanism. If a consumer chooses to provide feedback and demonstrates his/her recognition of the advertizing message, then the current advertisement is skipped and the consumer is allowed to immediately go back to the media. If the consumer provides an incorrect answer, he/she is forced to view the remainder of the advertisement. Such a reward mechanism increases the likelihood of the consumer providing feedback and thus facilitates a viable pricing model based on the consumer feedback. Not being able to skip the advertisement due to a wrong answer trains the consumer to watch the ad more carefully and understand the advertisement message.

Traditionally, online brand awareness ads are priced with CPM (cost per impression), CPC (cost per click) or CPA (cost per acquisition). However, as described herein, advertisements can be priced by CPR (cost per recognition) such that advertisers are charged based on the actual effectiveness of the advertisement, measured by the consumer recognizing the advertising message and providing feedback demonstrating both understanding and engagement. From the perspective of a publisher-side ad management service, a CPR campaign can be implemented as a CPA campaign with the action event being triggered when the consumer selects the right answer during the recognition process.

A representative embodiment includes a method of determining advertisement pricing based on actual recognition of an advertising message by a consumer. The method can include presenting an advertisement on an interface where the advertisement has at least one advertising message, presenting a consumer feedback mechanism on the interface such that the consumer feedback mechanism is configured to receive an indication of recognition by a consumer of at least one advertising message, receiving the indication of recognition, and determining at a pricing computer an advertising price based at least in part on the received indication of recognition.

In a second representative embodiment, a system determines advertisement pricing based on actual recognition of an advertising message by a consumer. The system can include an advertisement computer configured to communicate an advertisement for presentation on an interface. The advertisement includes at least one advertising message. The advertisement computer is further configured to communicate a consumer feedback mechanism for presentation on the interface. The consumer feedback mechanism is configured to receive an indication of recognition by a consumer of at least one advertising message. The advertisement computer is configured to received the indication of recognition and determine an advertising price based at least in part on the received indication of recognition.

In a third representative embodiment, a method of determining advertisement pricing based on recognition of an advertising message by a consumer includes communicating, from an advertisement pricing computer, an advertisement and an advertisement feedback mechanism to a consumer computer, the advertisement including at least one advertising message. The method then includes receiving, at the advertisement pricing computer, a consumer response from the advertisement feedback mechanism presented on the consumer computer. The advertisement feedback mechanism is configured to obtain the consumer response, which indicates whether a consumer recognized at least one advertising message from the advertisement. The method further includes determining, at the advertisement pricing computer, an advertising price based at least in part on the received consumer response from the advertisement feedback mechanism.

Other principal features and advantages will become apparent to those skilled in the art upon review of the following drawings, the detailed description, and the appended claims.

### BRIEF DESCRIPTION OF THE DRAWINGS

Representative embodiments are hereafter described with reference to the accompanying drawings.

FIG. 1 is a flow diagram illustrating operations performed by an advertising pricing computer system in accordance with a representative embodiment.

FIG. 2 is a flow diagram illustrating operations in an advertising pricing system in accordance with a representative embodiment.

FIG. 3 is a graphical user interface of an advertisement in the system of FIG. 1 in accordance with a representative embodiment.

FIG. 4 is a graphical user interface of an advertisement in the system of FIG. 1 in accordance with a representative embodiment.

FIG. 5 is a flow diagram illustrating use of a reward mechanism with advertisement recognition feedback in accordance with a representative embodiment.

### DETAILED DESCRIPTION

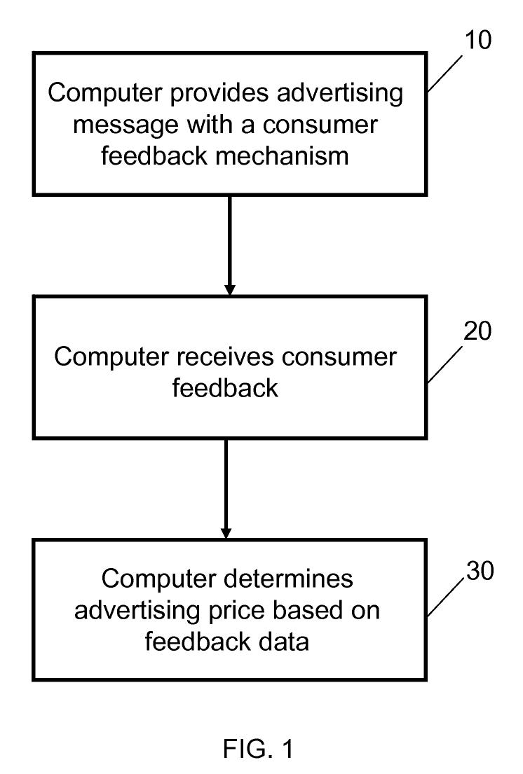

FIG. 1 illustrates a flow diagram of operations performed in an advertising pricing computer system. Additional, fewer, or different operations may be performed depending on the particular implementation. In an operation 10, a computer provides an advertising message with a consumer feedback mechanism. The computer can be a pricing computer or an advertising computer. The advertising message includes a product or service and a message, either explicit or implicit, about the product or service. The consumer feedback mechanism tests whether the consumer recognizes the message about the product or service that the advertisement is attempting to communicate.

In an operation 20, the computer receives consumer feedback from the consumer feedback mechanism. The consumer feedback can take the form of an answer to a multiple-choice question or a true-false question, or other mechanisms for determining if the message of the advertisement was recognized and understood. As an example, if the advertisement is about a body wash product, the consumer feedback mechanism can provide a question, such as “The (brand name) body wash is different than other brands because (a) it lasts for a long time, (b) it's cheaper than the competition, or (c) it's made from natural ingredients.” The correct answer is (c), based on the advertisement presented to the consumer. By selecting this option the consumer shows that he or she has understood the advertising message presented.

In an operation 30, the computer determines an advertising price for the advertisement based on feedback data including, for example, the number of consumers which understood and gave positive responses to the consumer feedback mechanism. The computer can be a pricing computer separate and apart from an advertising computer that supplies advertisements. Alternatively, the same computer can be used for both advertisement delivery and feedback. The advertisement price can be communicated to a billing system for charging the company offering the product or service advertised based on the consumer recognition of the advertising message.

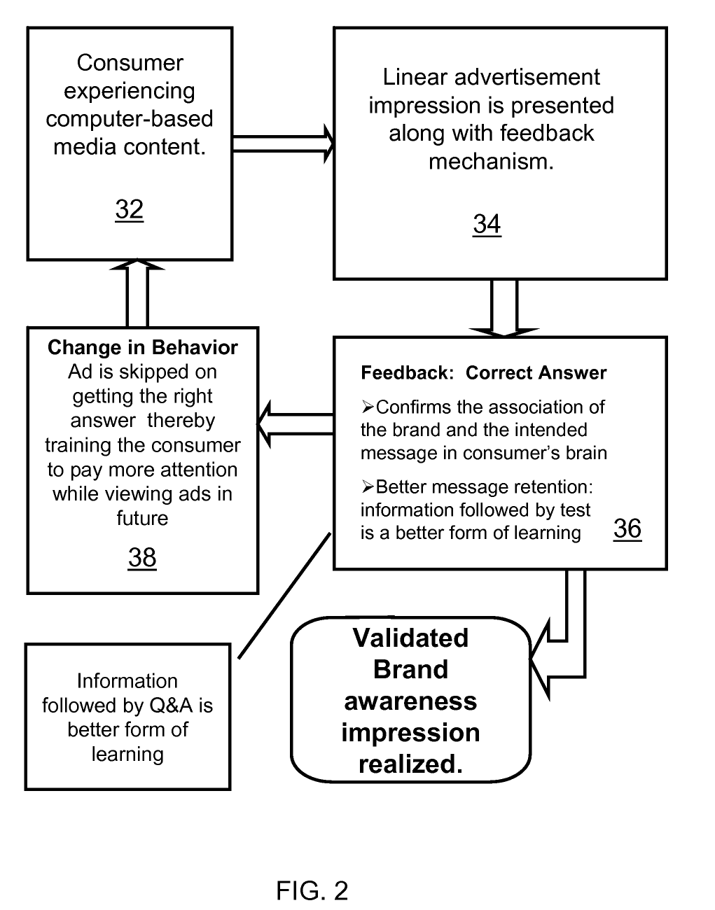

FIG. 2 illustrates a flow diagram of operations performed in an advertising pricing computer system. Additional, fewer, or different operations may be performed depending on the particular implementation. In an operation 32, a consumer is experiencing a computer-based media, such as a game, at a consumer computer. In the situation of a game, the game can be downloaded from an Internet web site or streamed on an Internet web site. Alternatively, the game can be a non-Internet game that is stored on a memory storage apparatus such as a CD-ROM or the like. In an operation 34, a linear advertisement is presented. In one embodiment, the linear advertisement is presented while the game is downloaded from an Internet site. Alternatively, the advertisement is presented while the game is loading or prior to beginning the game. The advertisement can also, in some implementations, be an interstitial advertisement that is presented during a break in the game at, for example, a change in levels of a game or at some other natural break in game play.

In an operation 36, the consumer of the media provides a response that indicates he or she has understood the advertising message of the advertisement presented in operation 34. The response can be an answer to a quiz question or a response like clicking a particular icon on the graphical user interface. A correct answer or correct feedback confirms the consumer's association of the brand and the intended message.

Once recognition of the advertising message has been determined, a validated brand awareness impression is realized. This validated impression can be used in a pricing model such as cost per recognition. That is, an advertiser is charged for the advertisement based on the fact that confirmation has been received that the advertisement was successfully delivered and understood. In an operation 38, the advertisement is removed from the interface, allowing the consumer to begin play or continue play. The removal of the advertisement teaches the consumer that when he or she is presented with a similar advertisement, the quickest way to remove the advertisement is to view the advertisement, understand the advertisement message, and provide a correct answer to the feedback question.

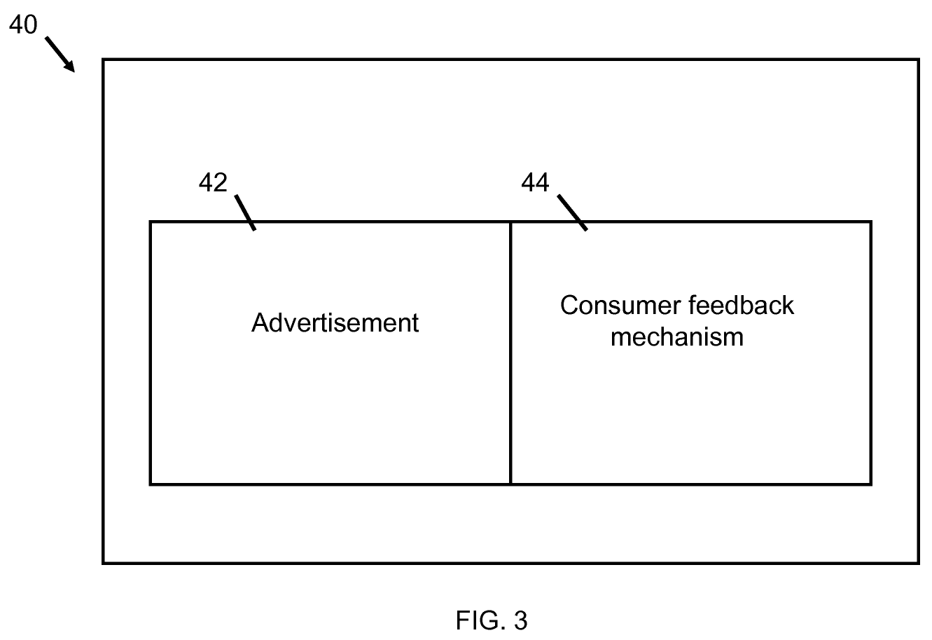

FIG. 3 illustrates a representative graphical user interface of an advertisement in the system of FIG. 1. A graphical user interface 40 includes an advertisement portion 42 and a feedback mechanism portion 44. The advertisement portion 42 can include any of a variety of different advertisements, including animated characters and/or video endorsement advertisements. The feedback mechanism portion 44 can be any of a variety of different mechanisms for determining whether a consumer recognized the advertisement. In at least one embodiment, the advertisement portion 42 and the feedback mechanism portion 44 are not visually separable but rather appear to be in the same interface, although technically one portion may or may not be overlaying the other.

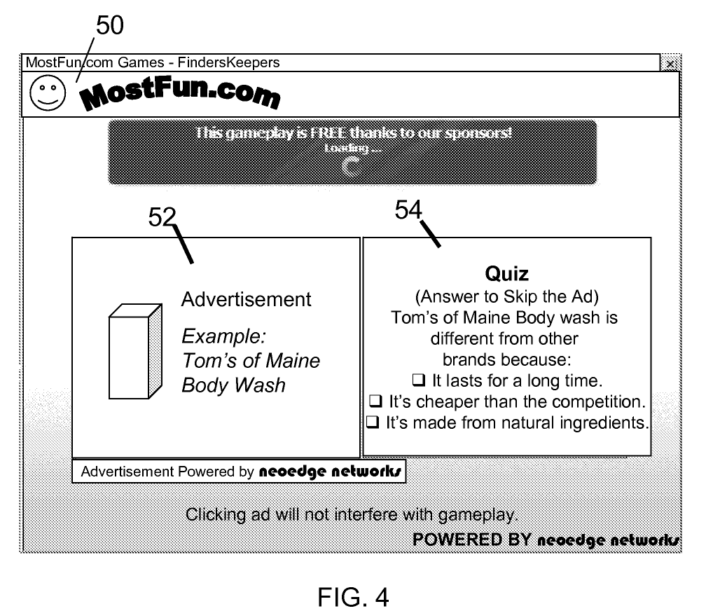

FIG. 4 illustrates an example graphical user interface 50 including an advertisement 52 and a feedback portion 54. In the advertisement 52, the example advertised body wash product is described as “Tom's of Maine Natural Moisturizing Body Wash.” The feedback portion 54 provides a multiple choice question for the user to determine if the user recognized or understood the message from the advertisement 52 that the product is made from natural ingredients. The advertisement remains on the display until an answer is received from the consumer. Alternatively, the advertisement remains on the display for a pre-determined length of time. In such a scenario, the length of time is such that the consumer prefers to answer the question rather than wait for the advertisement to be removed.

Advertisements that are priced based on consumer feedback can require the consumer of the media content to correctly identify a message of the advertisement. In the case of a brand awareness advertisement, the message can be identified by providing an answer to a quiz question or a response like clicking a particular icon on the graphical user interface. A correct answer or correct feedback confirms the consumer's association of the brand and the intended message.

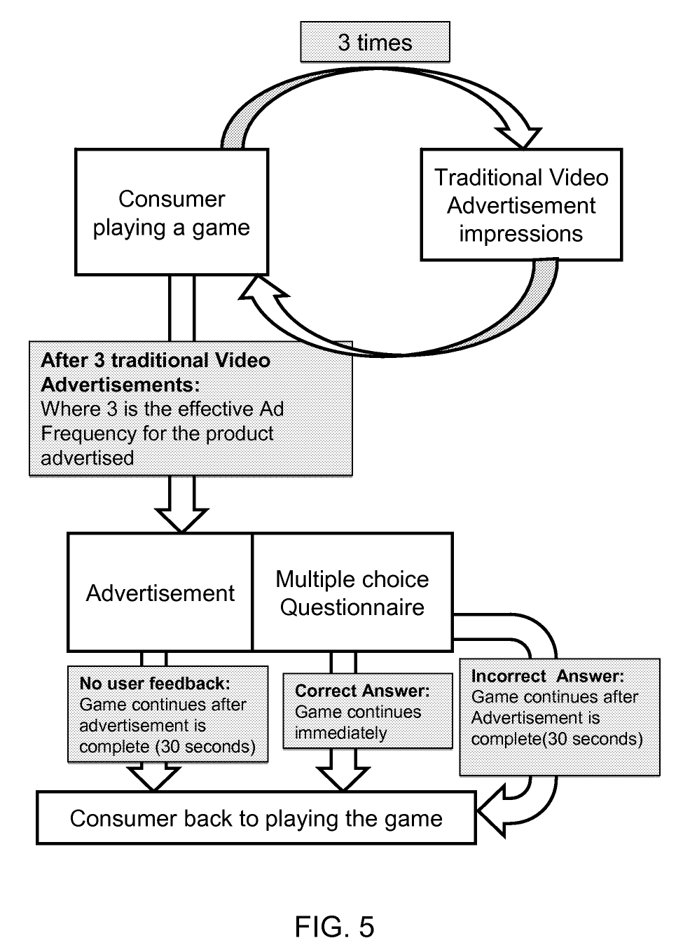

FIG. 5 demonstrates an implementation of a reward mechanism that can be tied to consumer for providing ad recognition feedback. The example demonstrates a video game media with a 30-second advertisement at every game level completed or after 5 minutes of game play. In this example, it is assumed that the effective frequency of the product being advertised is 3, which means that the consumer is expected to retain the advertisement message after 3 exposures to the advertisement. The consumer views a traditional 30-second video advertisement 3 times after 5 minutes of game play or at game level completion. The fourth time the advertisement is due, the same video advertisement is displayed, but this time with a multiple choice questionnaire as a companion. The questionnaire is designed to test the consumer's understanding of the advertising message. If a consumer selects the right answer, proving his/her understanding of the message, the consumer directly continues with the game. For example, if the consumer provides a correct answer in the first 10 seconds, he/she gets to directly continue the game right away. The immediate reward of skipping 20 seconds of advertisement by providing feedback showing their understanding of the message gives an incentive for the consumer to answer the questionnaire. If a consumer gives a wrong answer, the current advertisement continues for the whole 30 seconds. Being unable to skip the advertisement in this case trains the consumer to watch the advertisement more carefully the next time.

The foregoing description has been presented for purposes of illustration and of description. It is not intended to be exhaustive or limiting with respect to the precise form disclosed, and modifications and variations are possible in light of the above teachings or may be acquired from practice of the disclosed embodiments.

What is claimed is:

1. A method of advertising pricing based on actual recognition of an advertising message by a consumer, the method comprising:
presenting an advertisement on an interface, the advertisement including at least one advertising message;
presenting a consumer feedback mechanism on the interface, wherein the consumer feedback mechanism is configured to receive an indication of recognition by a consumer of the at least one advertising message;
receiving the indication of recognition; and
determining at a pricing computer an advertising price based at least in part on the received indication of recognition.

2. The method of claim 1, wherein the interface is a graphical user interface presented on an Internet browser interface.

3. The method of claim 1, wherein the consumer feedback mechanism includes a question related to the at least one advertising message.

4. The method of claim 3, wherein the question is a multiple choice question.

5. The method of claim 4, wherein the indication of recognition includes an answer to the multiple choice question.

6. The method of claim 1, further comprising communicating the advertising price to a billing computer, the billing computer being configured to generate a bill associated with the advertisement based at least in part on consumer recognition of the advertisement.

7. The method of claim 1, further comprising communicating the indication of recognition to a billing computer, the billing computer being configured to determine a cost of advertising for the advertisement.

8. A system for determining advertisement pricing based on actual recognition of an advertising message by a consumer, the system comprising:
an advertisement computer configured to communicate an advertisement for presentation on an interface, the advertisement including at least one advertising message;
wherein the advertisement computer is further configured to communicate a consumer feedback mechanism for presentation on the interface,
wherein the consumer feedback mechanism is configured to receive an indication of recognition by a consumer of the at least one advertising message; and
further wherein the advertisement computer is configured to received the indication of recognition and determine an advertising price based at least in part on the received indication of recognition.

9. The system of claim 8, further comprising a policy server computer configured to communicate advertisement policy associated with attributes of the advertisement and advertisement presentation.

10. The system of claim 8, further comprising an Internet interface coupled to the advertisement computer.

11. The system of claim 10, wherein advertisements are communicated via the Internet interface to programs on an Internet site.

12. The system of claim 11, wherein the programs include games.

13. The system of claim 12, wherein the advertisement and the consumer feedback mechanism are presented while a game program is downloaded from the Internet site to a consumer interface.

14. The system of claim 12, wherein the advertisement is removed from the Internet interface once a response is received from the consumer feedback mechanism.

15. The system of claim 8, wherein the consumer feedback mechanism includes a multiple choice question to determine consumer recognition of the at least one advertising message.

16. A method of determining advertisement pricing based on recognition of an advertising message by a consumer, the method comprising:
communicating, from an advertisement pricing computer, an advertisement and an advertisement feedback mechanism to a consumer computer, the advertisement including at least one advertising message;
receiving, at the advertisement pricing computer, a consumer response from the advertisement feedback mechanism presented on the consumer computer, wherein the advertisement feedback mechanism is configured to obtain the consumer response which indicates whether a consumer recognized the at least one advertising message from the advertisement; and
determining, at the advertisement pricing computer, an advertising price based at least in part on the received consumer response from the advertisement feedback mechanism.

17. The method of claim 16, wherein the advertisement and the advertisement feedback mechanism are communicated in response to a request to engage a computer program.

18. The method of claim 17, wherein the computer program is a computer game.

19. The method of claim 16, wherein the advertisement and the advertisement feedback mechanism are removed from display at the consumer computer once the consumer response is entered.

20. The method of claim 16, wherein the advertisement feedback mechanism includes a multiple-choice question.
